(19) United States
(12) Patent Application Publication
(10) Pub. No.: US 2026/0074125 A1
(43) Pub. Date: Mar. 12, 2026

(54) HYBRID CAPACITOR

(71) Applicant: GM Global Technology Operations LLC, Detroit, MI (US)

(72) Inventors: Yilun Luo, Ann Arbor, MI (US); Mohammad N. Anwar, Northville, MI (US); Chandra S. Namuduri, Troy, MI (US); Song He, Troy, MI (US); Khorshed Mohammed Alam, Canton, MI (US); Mohamed Kamel, Birmingham, MI (US)

(73) Assignee: GM Global Technology Operations LLC, Detroit, MI (US)

(21) Appl. No.: 18/826,769

(22) Filed: Sep. 6, 2024

(51) Int. Cl. H01G 15/00; B60L 15/00; B60L 50/64; B60L 53/22; H01G 2/02

(52) U.S. Cl. CPC H01G 15/00; B60L 15/007; B60L 50/64; B60L 53/22; H01G 2/02

(57) ABSTRACT

A hybrid capacitor includes a substrate having a first surface and a second surface opposite the first surface, a first end and a second end spaced from the first end, and a first side and a second side spaced from the first side. The hybrid capacitor further including one or more pins communicatively coupled to the substrate and one or more capacitors communicatively coupled to the substrate.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a vehicle and, more particularly, to a capacitor for vehicle electronics.

Conventional capacitors commonly rely on one type (film, electrolytic, ceramic, etc.) of capacitor. However, increasing performance (i.e., electrical, thermal, noise vibration harshness (NVH), etc.) can be difficult when relying on one type of capacitor. Shortcomings of existing systems will be addressed by one or more aspects of the present disclosure.

### SUMMARY

In one configuration, a hybrid capacitor is provided and includes a substrate, including a first surface and a second surface opposite the first surface, a first end and a second end spaced from the first end, and a first side and a second side spaced from the first side. The hybrid capacitor further includes one or more pins communicatively coupled to the substrate and one or more capacitors communicatively coupled to the substrate.

The hybrid capacitor may include one or more of the following aspects. For example, the one or more capacitors include one or more first capacitors communicatively coupled to the substrate, one or more second capacitors communicatively coupled to the substrate, and one or more third capacitors communicatively coupled to the substrate.

According to at least one aspect, the one or more first capacitors are ceramic capacitors, the one or more second capacitors are film capacitors, and the one or more third capacitors are electrolytic capacitors.

According to another aspect, the one or more first capacitors form a first row that is adjacent to the first end and extends between the first side and the second side, the one or more second capacitors form a second row that is adjacent to the first row and extends between the first side and the second side, and the one or more third capacitors form a third row that is adjacent to the second row and the second end and extends between the first side and the second side.

According to yet another aspect, the one or more first capacitors and the one or more third capacitors form a first column and a second column that extends between the first end and the second end, and the one or more first capacitors and the one or more third capacitors form a third column that extends between the first end and the second end and is arranged between the first column and the second column. At least some of the one or more first capacitors, the one or more second capacitors, the one or more third capacitors, and at least a portion of the first surface of the substrate can be encapsulated with a thermally insulative resin.

According to at least one example, the hybrid capacitor includes one or more outer regions and one or more inner regions. The one or more first capacitors and the one or more second capacitors can be arranged in the one or more inner regions and the one or more third capacitors can be arranged in the one or more outer regions. Alternatively, the one or more first capacitors and the one or more third capacitors can be arranged in the one or more inner regions and the one or more second capacitors can be arranged in the one or more outer regions.

According to at least one aspect, the one or more capacitors can include one or more first capacitors, one or more second capacitors, and one or more third capacitors, and the hybrid capacitor can include a first region that is adjacent to the first end and includes the one or more first capacitors, a second region that is adjacent to the first region, the first side, and the second end and includes the one or more second capacitors, and a third region that is adjacent to the first region, the second region, the second side, and the second end and includes the one or more third capacitors.

In another configuration, a vehicle is provided and includes a vehicle body, a vehicle battery coupled to the vehicle body, a motor communicatively coupled to the vehicle battery, and an inverter communicatively coupled to the vehicle battery and the motor and having a hybrid capacitor. The hybrid capacitor including a substrate having a first surface and a second surface opposite the first surface, a first end and a second end spaced from the first end, and a first side and a second side spaced from the first side. The hybrid capacitor further including one or more pins communicatively coupled to the substrate, one or more first capacitors communicatively coupled to the substrate, one or more second capacitors communicatively coupled to the substrate, and one or more third capacitors communicatively coupled to the substrate.

The vehicle may include one or more of the following optional aspects. For example, the one or more first capacitors and the one or more second capacitors are film capacitors and the one or more third capacitors are ceramic capacitors. The one or more first capacitors can be configured to withstand higher temperatures than the one or more second capacitors.

According to another aspect, the one or more first capacitors are ceramic capacitors, the one or more second capacitors are electrolytic capacitors, and the one or more third capacitors are film capacitors. The one or more first capacitors form a first row adjacent to the first end and that extends between the first side and the second side, the one or more second capacitors form a second row adjacent to the first row and that extends between the first side and the second side, and the one or more third capacitors form a third row that is adjacent to the second row and the second end and that extends between the first side and the second side.

In yet another configuration, a vehicle is provided and includes a vehicle body, a vehicle battery coupled to the vehicle body, a motor communicatively coupled to the vehicle battery, and an onboard charging module (OBCM) communicatively coupled to the vehicle battery and the motor and having a hybrid capacitor. The hybrid capacitor including a substrate having a first surface and a second surface opposite the first surface, a first end and a second end spaced from the first end, and a first side and a second side spaced from the first side. The hybrid capacitor further including one or more pins communicatively coupled to the substrate, one or more first capacitors communicatively coupled to the substrate, one or more second capacitors communicatively coupled to the substrate, and one or more third capacitors communicatively coupled to the substrate, at least one of the one or more first, second, or third capacitors are encapsulated with a thermally insulative resin.

The vehicle may include one or more of the following optional aspects. For example, the one or more first capacitors and the one or more second capacitors are film capacitors and the one or more third capacitors are ceramic capacitors. The one or more first capacitors can be configured to withstand higher temperatures than the one or more second capacitors.

According to another aspect, the one or more first capacitors are ceramic capacitors, the one or more second capacitors are electrolytic capacitors, and the one or more third capacitors are film capacitors. The one or more first capacitors form a first row adjacent to the first end and that extends between the first side and the second side, the one or more second capacitors form a second row adjacent to the first row and that extends between the first side and the second side, and the one or more third capacitors form a third row that is adjacent to the second row and the second end and that extends between the first side and the second side.

### BRIEF DESCRIPTION OF THE DRAWINGS

The drawings described herein are for illustrative purposes only of selected configurations and are not intended to limit the scope of the present disclosure.

FIG. 1 is a front perspective view of a vehicle according to principles of the present disclosure;

FIG. 2 is a top perspective view of an inverter including one or more hybrid capacitors according to principles of the present disclosure;

FIG. 3 is a top view of an onboard charging module (OBCM) including one or more hybrid capacitors according to principles of the present disclosure;

FIG. 4 is a configuration of a hybrid capacitor according to principles of the present disclosure;

FIG. 5 is another configuration of a hybrid capacitor according to principles of the present disclosure;

FIG. 6 is another configuration of a hybrid capacitor according to principles of the present disclosure;

FIG. 7 is another configuration of a hybrid capacitor according to principles of the present disclosure;

FIG. 8 is another configuration of a hybrid capacitor according to principles of the present disclosure;

FIG. 9 is a graph comparing electrical performance of one or more existing capacitors with a hybrid capacitor according to principles of the present disclosure;

FIG. 10 is another configuration of a hybrid capacitor according to principles of the present disclosure;

FIG. 11 is another configuration of a hybrid capacitor according to principles of the present disclosure;

FIG. 12 is another configuration of a hybrid capacitor according to principles of the present disclosure;

FIG. 13 is another configuration of a hybrid capacitor according to principles of the present disclosure;

FIG. 14 is another configuration of a hybrid capacitor according to principles of the present disclosure; and

FIG. 15 is another configuration of a hybrid capacitor according to principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

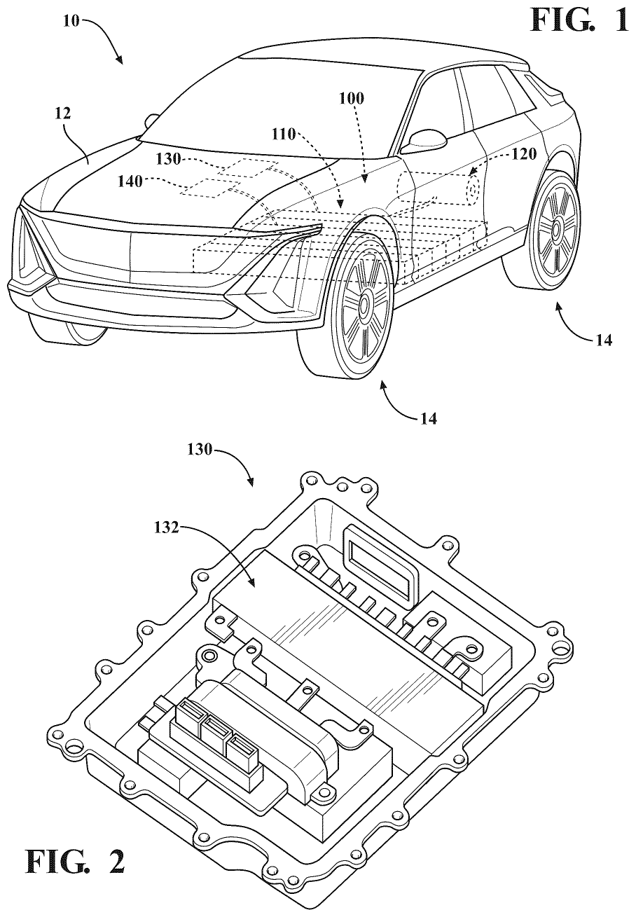

With reference to FIG. 1, an illustrative example of a vehicle 10 (e.g., an electric vehicle) having a vehicle body 12 is provided. The vehicle 10 includes one or more wheels 14 coupled to the vehicle body 12. Additionally, the vehicle 10 includes a powertrain system 100 coupled to and configured to provide power to the one or more wheels 14 to propel the vehicle 10. The powertrain system 100 can include a battery pack 110 and a motor 120 communicatively coupled to the battery pack 110. The powertrain system 100 can also include an inverter 130 and/or an onboard charging module (OBCM) 140. Note, the principles of the present disclosure are discussed with respect to an automobile, however, the principles equally apply to other types of vehicles (e.g., trains, planes, etc.) as well as power generating devices, such as turbines.

With reference to FIG. 2, an illustrative example of the inverter 130 is provided. The inverter 130 can be configured to convert direct current (DC) power to alternating current (AC) power that can be used by the motor 120. Commonly, inverters include one or more capacitors, sometimes referred to as a distributed capacitor 142, arranged at a DC input terminal to ensure a smooth conversion from DC power to AC power, for example. As will be discussed below, a hybrid capacitor may be used to improve thermal and/or electrical performance of the distributed capacitor 142 while being conscious of cost and packaging size.

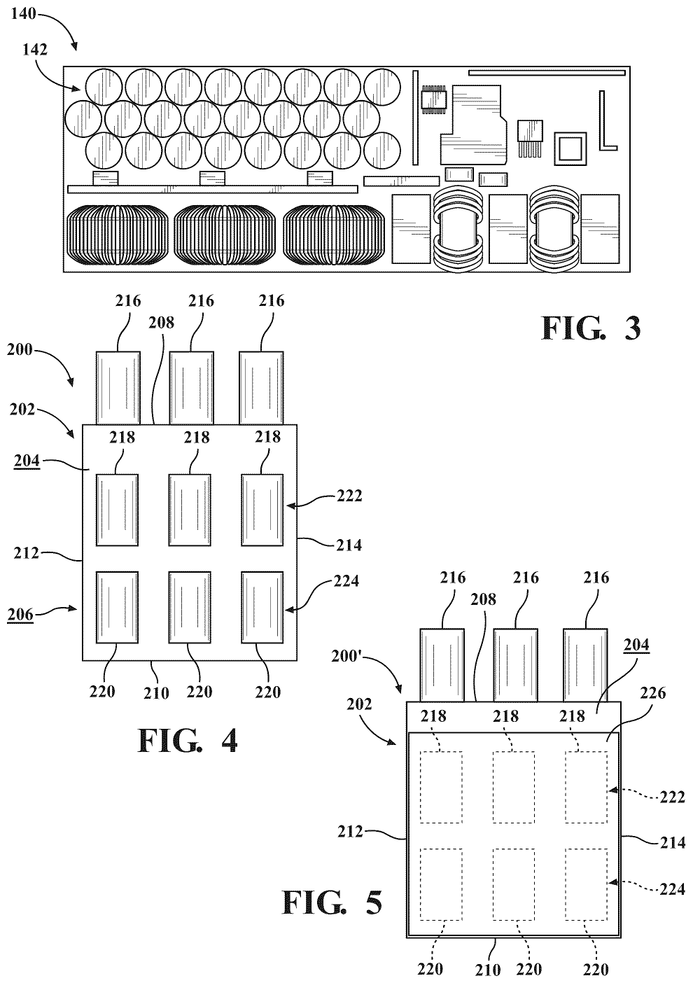

With reference to FIG. 3, an illustrative example of the OBCM 140 is provided. The OBCM 140 can be configured to convert AC power from external sources, such as residential outlets, to DC power to charge the battery pack 110, for example. The OBCM 140 can include one or more capacitors, sometimes referred to as a bulk capacitor 132, to stabilize the DC power that is charging the battery pack 110. Existing solutions commonly rely on aluminum electrolytic capacitors which have voltage ratings up to 500 volts (V), a capacitance up to 820 microfarad (μF), and ripple current capabilities at an operating temperature range of −40 degrees Celsius (°C) to 105° C. As will be discussed below, the hybrid capacitor may be used to improve thermal and/or electrical performance of the bulk capacitor 132 while being conscious of cost and packaging size.

Several illustrative configurations of the hybrid capacitor are provided in FIGS. 4-8 and FIGS. 9-15. These configurations are similar in many respects. Accordingly, the following descriptions are incorporated into one another, and description common to the configurations generally may not be repeated.

With reference to FIG. 4, an illustrative configuration of a hybrid capacitor 200 is provided. The hybrid capacitor 200 includes a substrate 202 (e.g., a printed circuit board (PCB)) that has a first surface 204 and a second surface 206 opposite the first surface 204. The substrate 202 also has a first end 208 and a second end 210 spaced from the first end 208, and a first side 212 and a second side 214 spaced from the first side 212. One or more pins 216 are communicatively coupled to the substrate 202. In the present illustrative example, the one or more pins 216 are coupled to and extend away from the first end 208. The hybrid capacitor 200 further includes one or more first capacitors 218 and one or more second capacitors 220 communicatively coupled to the first and/or second surface 204, 206 of the substrate 202. According to one aspect, the one or more first capacitors 218 are coupled to the substrate 202 between the pins 216 and the one or more second capacitors 220. The one or more second capacitors 220 can be coupled to the substrate 202 between the one or more first capacitors 218 and the second end 210. According to another aspect, the one or more first capacitors 218 can form a first row 222 that extends between the first side 212 and the second side 214. Similarly, the one or more second capacitors 220 can form a second row 224 that extends between the first side 212 and the second side 214. According to one aspect, the one or more first capacitors 218 can include a first temperature operating range having a first upper limit and the one or more second capacitors 220 can include a second temperature operating range having a second upper limit. In the present illustrative configuration, the first upper limit is greater than the second upper limit. In other words, the one or more first capacitors 218 can withstand higher temperatures and can be arranged in a high temperature region (e.g., a region near one or more power switches) of the substrate 202 to balance a temperature distribution across the substrate 202, for example. The one or more first capacitors 218 and the one or more second capacitors 220 can be film capacitors that have a capacitance between 400 μF and 900 μF. According to at least one aspect, the one or more first capacitors 218 can have a first temperature rating and the one or more second capacitors 220 can have a second temperature rating that is the same or different than the first temperature rating.

With reference to FIG. 5, an illustrative configuration of a hybrid capacitor 200′ is provided. The hybrid capacitor is similar to the hybrid capacitor 200. However, the hybrid capacitor 200′ includes an electrically insulative resin 226 that encapsulates the one or more first capacitors 218, the one or more second capacitors 220, and at least a portion of the substrate 202. The electrically insulative resin 226 seals the one or more first capacitors 218 and the one or more second capacitors 220 from the elements (e.g., air, wind, water, etc.) and secures the position of the capacitors 218, 220 with respect to the substrate 202. Typically, capacitors include individual casings that insulate and protect the capacitors, however, when using the insulative resin 226, the individual casings are not required.

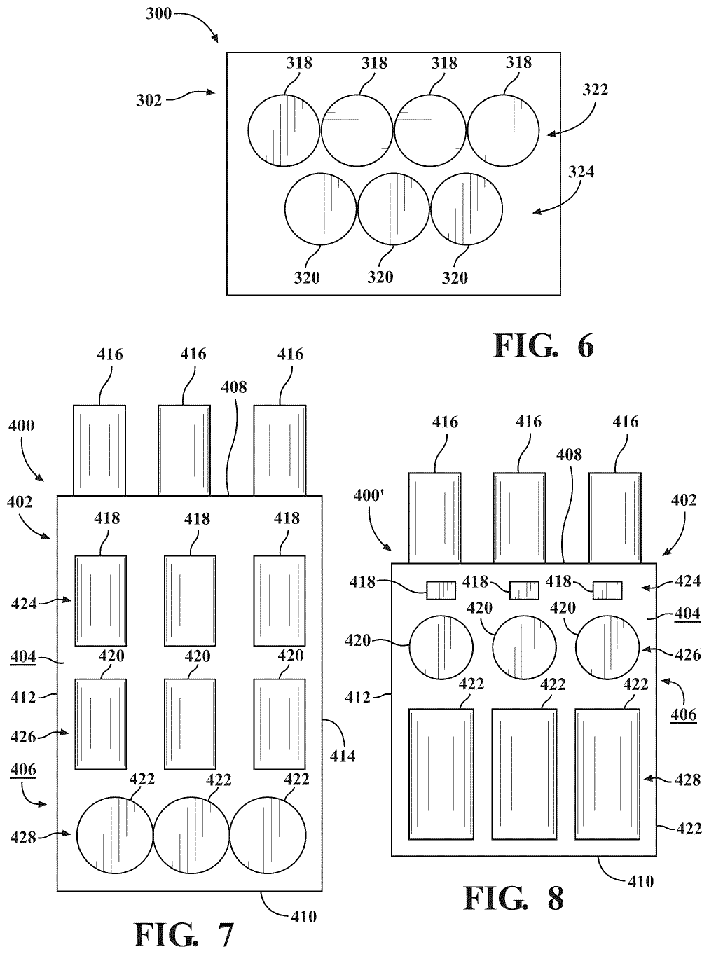

With reference to FIG. 6, an illustrative configuration of a hybrid capacitor 300 is provided. The hybrid capacitor 300 is similar to the hybrid capacitor 200. For instance, the hybrid capacitor 300 includes a first row 322 of one or more first capacitors 318 and a second row 324 of one or more second capacitors 320 coupled to a substrate 302. In the present configuration, the one or more first capacitors 318 and the one or more second capacitors 320 are both electrolytic-type capacitors. In general, electrolytic capacitors are desirable for filtering low frequencies.

With reference to FIG. 7, an illustrative configuration of a hybrid capacitor 400 is provided. The hybrid capacitor 400 includes a substrate 402 (e.g., a printed circuit board (PCB)) that has a first surface 404 and a second surface 406 opposite the first surface 404. The substrate 402 also has a first end 408 and a second end 410 spaced from the first end 408 and a first side 412 and a second side 414 spaced from the first side 412. One or more pins 416 are communicatively coupled to the substrate 402. In the present illustrative example, the one or more pins 416 are coupled to and extend away from the first end 408. The hybrid capacitor 400 further includes one or more first capacitors 418, one or more second capacitors 420, and one or more third capacitors 422 communicatively coupled to the substrate 402. According to one aspect, the one or more first capacitors 418 are coupled to the substrate 402 between the pins 416 and the one or more second capacitors 420. The one or more second capacitors 420 can be coupled to the substrate 402 between the first capacitors 418 and the third capacitors 422. The one or more third capacitors 422 can be coupled to the substrate 402 between the one or more second capacitors 420 and the second end 410. According to another aspect, the one or more first capacitors 418 can form a first row 424 that is adjacent the first end 408 and extends between the first side 412 and the second side 414. Similarly, the one or more second capacitors 420 can form a second row 426 that is adjacent to the first row 424 and extends between the first side 412 and the second side 414. The one or more third capacitors 422 can form a third row 428 that is adjacent to the second row 426 and the second end 410 and extends between the first side 412 and the second side 414. In the present configuration, the one or more first capacitors 418 are film capacitors, the one or more second capacitors are film capacitors, and the one or more third capacitors 422 are electrolytic capacitors. In another configuration of the hybrid capacitor 400′, as shown in FIG. 8, the one or more first capacitors 418 are ceramic capacitors, the one or more second capacitors 420 are electrolytic capacitors, and the one or more third capacitors 422 are film capacitors.

Utilizing more than one type (i.e., film, electrolytic, film, etc.) for the hybrid capacitor can be desirable to improve overall performance (e.g., thermal, electrical, noise vibration harshness (NVH), etc.). Combining capacitors of different capacitance (C), equivalent series inductance (ESL), and equivalent series resistance (ESR) can be desirable for distributing individual capacitor current over a frequency range to avoid current distribution imbalance which can reduce the temperate of regions near one or more power switches or hot spots and overall capacitor temperature. More particularly, high Tₘₐₓ capacitors can be used in regions near one or more power switches or hot spots while low Tₘₐₓ capacitors can be used for cooler locations. According to one aspect, selecting from more than one capacitor type that have different frequency responses is desirable for extending ripple suppression range and enabling filtering of low frequency content for 6-step Pulse Width Module (PWM) or high modulation index (MI) operation, for example. Combining ESL capacitors can be desirable for bypassing and/or suppressing I and V ripples for wide-bandgap (WBG) power electronics, SiC, GaN, Ga2O3, AlN, or diamond, for example.

Additionally, utilizing more than one type (i.e., film, electrolytic, film, etc.) for the hybrid capacitor can be desirable for reducing loop size and enabling faster switching and, thus, reducing stress on the power switches and hybrid capacitor. Having a smaller loop size can be desirable for reducing parasitic losses while improving switching loss, efficiency, NVH performance, and reliability of the hybrid capacitor. Additionally, distributing capacitors that have different resonances can be desirable to avoid common resonances and thus improve NVH performance and reliability. According to another aspect, cost and size of the hybrid capacitor can be reduced by selecting capacitors that have a spectrum of capacitance density. Typically, capacitors with a lower capacitance density are cheaper than those with a high capacitance density.

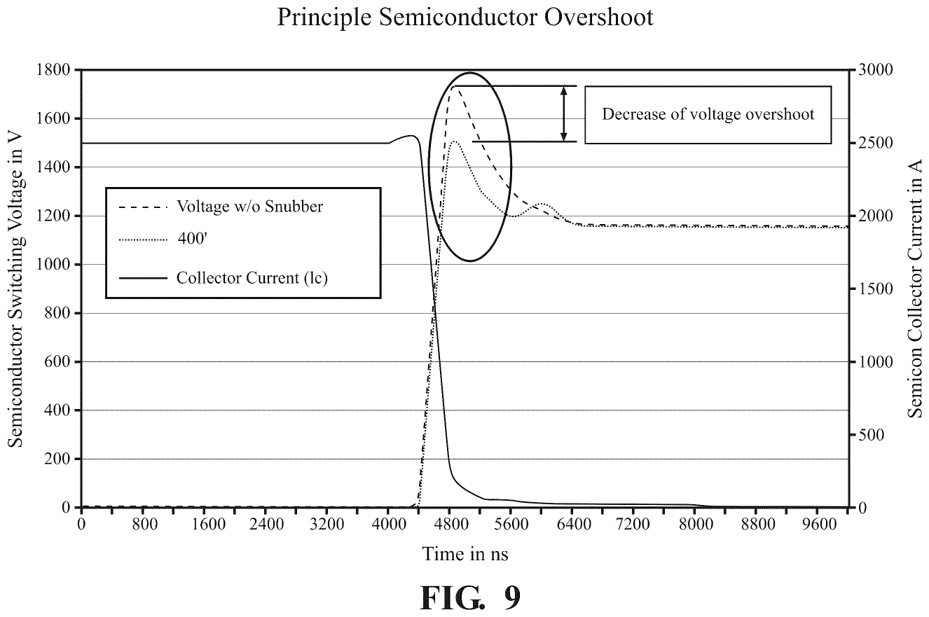

With reference to FIG. 9, a graph showing performance of the hybrid capacitor 400′ which includes electrolytic, film, and ceramic capacitors versus one or more existing capacitors that rely on film and/or electrolytic capacitors. As show in the graph, performance of the hybrid capacitor 400′, at least with respect to voltage overshoot across a power switch (e.g., a transistor), is improved when compared to existing designs.

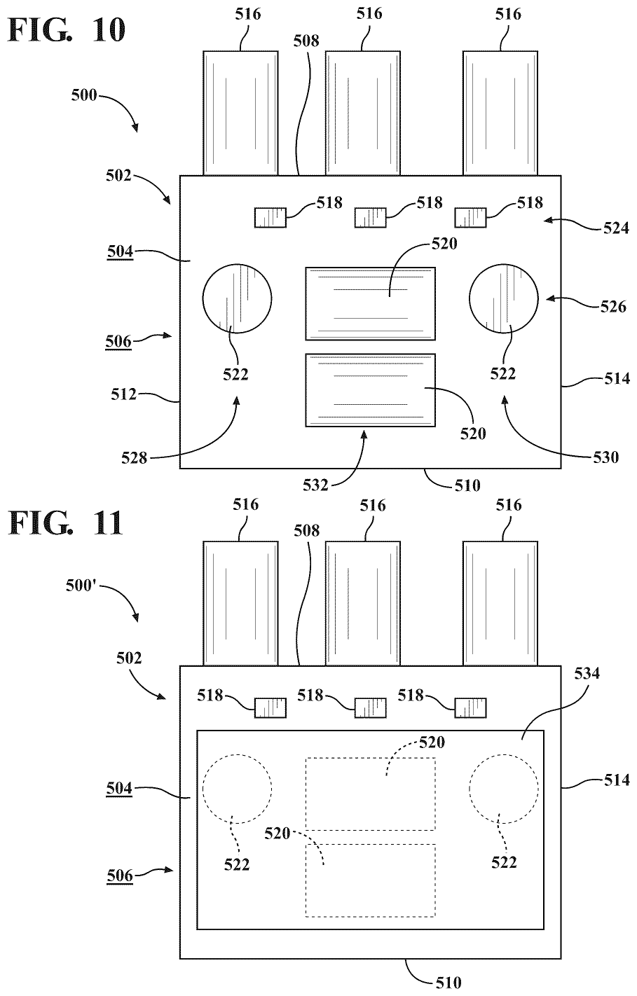

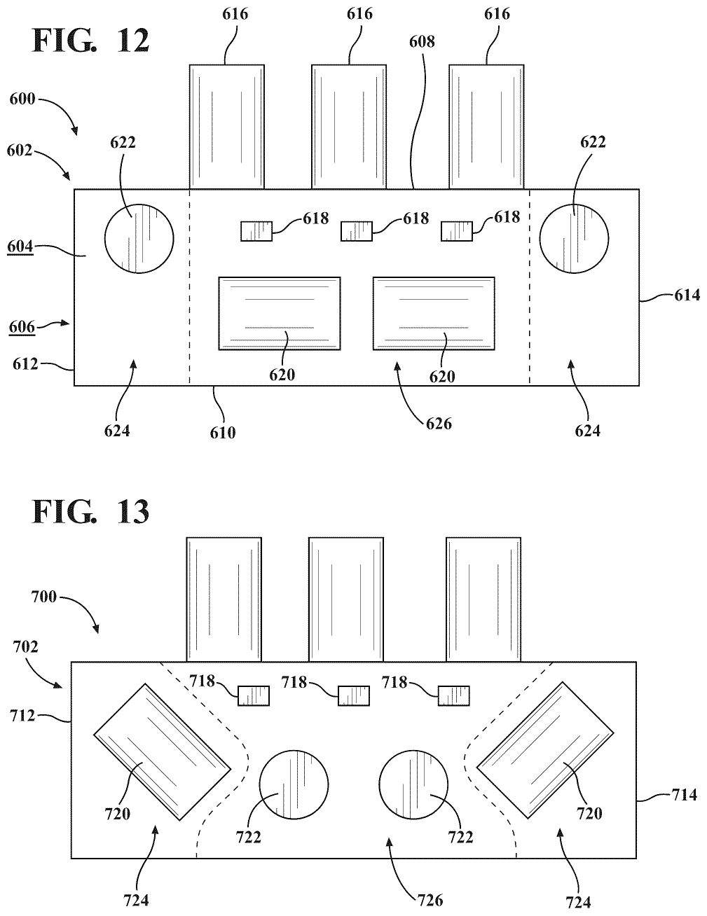

With reference to FIG. 10, an illustrative configuration of a hybrid capacitor 500 is provided. The hybrid capacitor 500 includes a substrate 502 (e.g., a printed circuit board (PCB)) that has a first surface 504 and a second surface 506 opposite the first surface 504. The substrate 502 also has a first end 508 and a second end 510 spaced from the first end 508 and a first side 512 and a second side 514 spaced from the first side 512. One or more pins 516 are communicatively coupled to the substrate 502. In the present illustrative example, the one or more pins 516 are coupled to and extend away from the first end 508. The hybrid capacitor 500 further includes one or more first capacitors 518, one or more second capacitors 520, and one or more third capacitors 522 communicatively coupled to the substrate 502. According to one aspect, the one or more first capacitors 518 are coupled to the substrate 502 and arranged adjacent to the one or more pins 516. The one or more second capacitors 520 are arranged between the one or more first capacitors 518 and the second end 510. The one or more third capacitors 522 can be spaced laterally between the one or more second capacitors 520 and the first and/or second sides 514. In the present illustrative configuration, the one or more first capacitors 518 are ceramic capacitors, the one or more second capacitors 520 are film capacitors, and the one or more third capacitors 522 are electrolytic capacitors. Additionally, as best shown in FIG. 12, the one or more first capacitors 518 form a first row 524 that extends between the first side 512 and the second side 514. Similarly, the one or more second capacitors 520 and the one or more third capacitors 522 form a second row 526 that extends between the first side 512 and the second side 514. The one or more first capacitors 518 and the one or more third capacitors 522 form a first or left column 528 and a second or right column 530 that extends between the first end 508 and the second end 510. The one or more first capacitors 518 and the one or more second capacitors 520 form a third or center column 532 that extends between the first end 508 and the second end 510 and is arranged between the first column 528 and the second column 530. In another configuration, with reference to FIG. 11, the hybrid capacitor 500′ can have a thermally insulative resin 534 that encapsulates one or more of the one or more first capacitors 518, the one or more second capacitors 520, the one or more third capacitors 522, and a least a portion of the first surface 504 of the substrate 502.

With reference to FIG. 12, an illustrative configuration of a hybrid capacitor 600 is provided. The hybrid capacitor 600 includes a substrate 602 (e.g., a printed circuit board (PCB)) that has a first surface 604 and a second surface 606 opposite the first surface 604. The substrate 602 also has a first end 608 and a second end 610 spaced from the first end 608 and a first side 612 and a second side 614 spaced from the first side 612. One or more pins 616 are communicatively coupled to the substrate 602. In the present illustrative example, the one or more pins 616 are coupled to and extend away from the first end 608. The hybrid capacitor 600 further includes one or more first capacitors 618, one or more second capacitors 620, and one or more third capacitors 622 communicatively coupled to the substrate 602. In the present illustrative configuration, the one or more first capacitors 618 are ceramic capacitors, the one or more second capacitors 620 are film capacitors, and the one or more third capacitors 622 are electrolytic capacitors. The hybrid capacitor 600 can further include first or outer regions 624 and a second or inner region 626. The outer regions 624 define the first side 612 and the second side 614 and each extend between the first end 608 and the second end 610. The inner region 626 is arranged between the outer regions 624 and extends between the first end 608 and the second end 610. The inner region 626 includes the one or more first capacitors 618 and the one or more second capacitors 620 and the outer regions 624 include the one or more third capacitors 622.

With reference to FIG. 13, an illustrative configuration of a hybrid capacitor 700 is provided. This configuration is similar in many respects to the hybrid capacitor 600. One or more first capacitors 718 and one or more third capacitors 722 are arranged in an inner region 726 of a substrate 702 and one or more second capacitors 720 are arranged in outer regions 724 of the substrate 702. The one or more second capacitors can be arranged at an angle with respect to first and/or second sides 712, 714, for example.

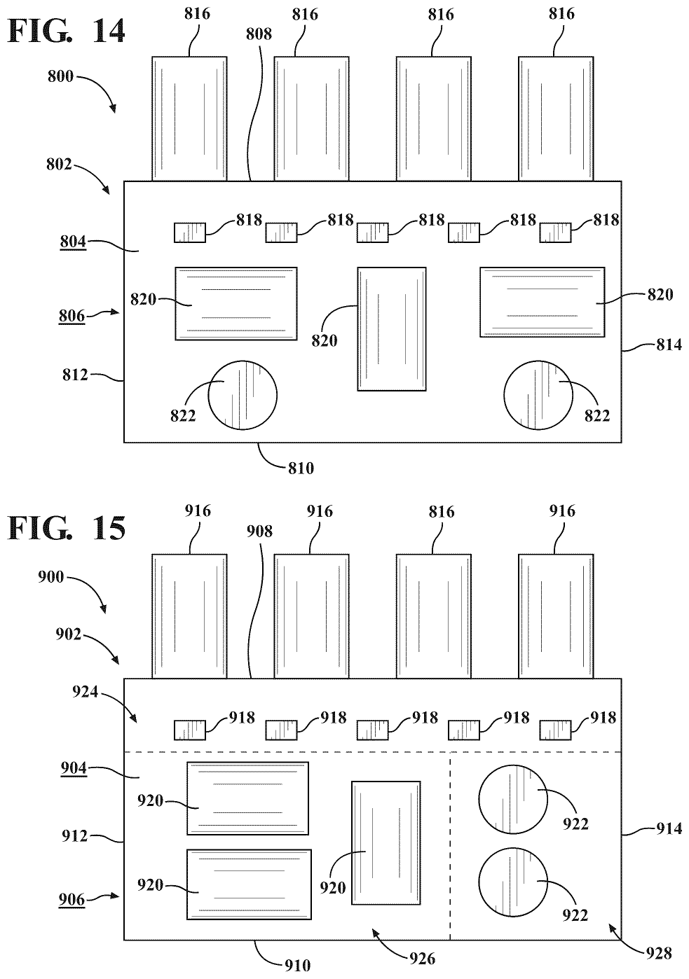

With reference to FIG. 14, an illustrative configuration of a hybrid capacitor 800 is provided. The hybrid capacitor 800 includes a substrate 802 (e.g., a printed circuit board (PCB)) that has a first surface 804 and a second surface 806 opposite the first surface 804. The substrate 802 also has a first end 808 and a second end 810 spaced from the first end 808 and a first side 812 and a second side 814 spaced from the first side 812. One or more pins 816 are communicatively coupled to the substrate 802. In the present illustrative example, the one or more pins 816 are coupled to and extend away from the first end 808. The hybrid capacitor 800 further includes one or more first capacitors 818, one or more second capacitors 820, and one or more third capacitors 822 communicatively coupled to the substrate 802. According to one aspect, the one or more first capacitors 818 are coupled to the substrate 802 and arranged adjacent to the one or more pins 816. The one or more second capacitors 820 are arranged between the one or more first capacitors 818 and the second end 810. As best shown in FIG. 14, some of the one or more second capacitors 820 can be arranged parallel to the one or more first capacitors 818 while at least one of the one or more second capacitors 820 is arranged perpendicular to the one or more first capacitors 818. The one or more third capacitors 822 can be arranged between the one or more second capacitors 820 and the second end 810. In the present illustrative configuration, the one or more first capacitors 818 are ceramic capacitors, the one or more second capacitors 820 are film capacitors, and the one or more third capacitors 822 are electrolytic capacitors. In general, film capacitors can be used to reduce changes in voltage (i.e., dV/dt) and ceramic capacitors can be used to reduce changes in current (i.e., dI/dt).

With reference to FIG. 15, an illustrative configuration of a hybrid capacitor 900 is provided. The hybrid capacitor 900 includes a substrate 902 (e.g., a printed circuit board (PCB)) that has a first surface 904 and a second surface 906 opposite the first surface 904. The substrate 902 also has a first end 908 and a second end 910 spaced from the first end 908 and a first side 912 and a second side 914 spaced from the first side 912. One or more pins 916 are communicatively coupled to the substrate 902. In the present illustrative example, the one or more pins 916 are coupled to and extend away from the first end 908. The hybrid capacitor 900 further includes one or more first capacitors 918, one or more second capacitors 920, and one or more third capacitors 922 communicatively coupled to the substrate 902. According to one aspect, the one or more first capacitors 918 are coupled to the substrate 802 and arranged in a first region 924 that is adjacent to the one or more pins 816. The one or more second capacitors 920 are arranged in a second region 926 that is adjacent the first region 924, the first side 912, and the second end 910. The one or more third capacitors 922 are arranged in a third region 928 that is adjacent to the first region 924, the second region 926, the second side 914, and the second end 910. In the present illustrative configuration, the one or more first capacitors 818 are ceramic capacitors, the one or more second capacitors 820 are film capacitors, and the one or more third capacitors 822 are electrolytic capacitors.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A hybrid capacitor, comprising:
a substrate, comprising:
a first surface and a second surface opposite the first surface,
a first end and a second end spaced from the first end, and
a first side and a second side spaced from the first side;
one or more pins communicatively coupled to the substrate; and
one or more capacitors communicatively coupled to the substrate.

2. The hybrid capacitor of claim 1, wherein the one or more capacitors include one or more first capacitors communicatively coupled to the substrate, one or more second capacitors communicatively coupled to the substrate, and one or more third capacitors communicatively coupled to the substrate.

3. The hybrid capacitor of claim 2, wherein the one or more first capacitors are ceramic capacitors, the one or more second capacitors are film capacitors, and the one or more third capacitors are electrolytic capacitors.

4. The hybrid capacitor of claim 3, wherein the one or more first capacitors form a first row that is adjacent to the first end and extends between the first side and the second side, the one or more second capacitors form a second row that is adjacent to the first row and extends between the first side and the second side, and the one or more third capacitors form a third row that is adjacent to the second row and the second end and extends between the first side and the second side.

5. The hybrid capacitor of claim 3, wherein the one or more first capacitors and the one or more third capacitors form a first column and a second column that extends between the first end and the second end, and the one or more first capacitors and the one or more third capacitors form a third column that extends between the first end and the second end and is arranged between the first column and the second column.

6. The hybrid capacitor of claim 5, wherein at least some of the one or more first capacitors, the one or more second capacitors, the one or more third capacitors, and at least a portion of the first surface of the substrate are encapsulated with a thermally conductive resin.

7. The hybrid capacitor of claim 2, wherein the substrate includes one or more outer regions and one or more inner regions.

8. The hybrid capacitor of claim 7, wherein the one or more first capacitors and the one or more second capacitors are arranged in the one or more inner regions and the one or more third capacitors are arranged in the one or more outer regions.

9. The hybrid capacitor of claim 7, wherein the one or more first capacitors and the one or more third capacitors are arranged in the one or more inner regions and the one or more second capacitors are arranged in the one or more outer regions.

10. The hybrid capacitor of claim 1, wherein the one or more capacitors include one or more first capacitors, one or more second capacitors, and one or more third capacitors, and the hybrid capacitor includes a first region that is adjacent to the first end and includes the one or more first capacitors, a second region that is adjacent to the first region, the first side, and the second end and includes the one or more second capacitors, and a third region that is adjacent to the first region, the second region, the second side, and the second end and includes the one or more third capacitors.

11. A vehicle, comprising:
a vehicle body;
a vehicle battery coupled to the vehicle body;
a motor communicatively coupled to the vehicle battery; and
an inverter communicatively coupled to the vehicle battery and the motor and having a hybrid capacitor, comprising:
a substrate, comprising:
a first surface and a second surface opposite the first surface,
a first end and a second end spaced from the first end, and
a first side and a second side spaced from the first side;
one or more pins communicatively coupled to the substrate;
one or more first capacitors communicatively coupled to the substrate;
one or more second capacitors communicatively coupled to the substrate; and
one or more third capacitors communicatively coupled to the substrate.

12. The vehicle of claim 11, wherein the one or more first capacitors and the one or more second capacitors are film capacitors and the one or more third capacitors are ceramic capacitors.

13. The vehicle of claim 12, wherein the one or more first capacitors are configured to withstand higher temperatures than the one or more second capacitors.

14. The vehicle of claim 11, wherein the one or more first capacitors are ceramic capacitors, the one or more second capacitors are electrolytic capacitors, and the one or more third capacitors are film capacitors.

15. The vehicle of claim 14, wherein the one or more first capacitors form a first row adjacent to the first end and that extends between the first side and the second side, the one or more second capacitors form a second row adjacent to the first row and that extends between the first side and the second side, and the one or more third capacitors form a third row that is adjacent to the second row and the second end and extends between the first side and the second side.

16. A vehicle, comprising:
a vehicle body;
a vehicle battery coupled to the vehicle body;
a motor communicatively coupled to the vehicle battery; and
an onboard charging module (OBCM) communicatively coupled to the vehicle battery and the motor and having a hybrid capacitor, comprising:
a substrate, comprising:
a first surface and a second surface opposite the first surface,
a first end and a second end spaced from the first end, and
a first side and a second side spaced from the first side;
one or more pins communicatively coupled to the substrate;
one or more first capacitors communicatively coupled to the substrate;
one or more second capacitors communicatively coupled to the substrate; and
one or more third capacitors communicatively coupled to the substrate, and at least one of the one or more first, second, or third capacitors are encapsulated with a thermally insulative resin.

17. The vehicle of claim 16, wherein the one or more first capacitors and the one or more second capacitors are film capacitors and the one or more third capacitors are ceramic capacitors.

18. The vehicle of claim 17, wherein the one or more first capacitors are configured to withstand higher temperatures than the one or more second capacitors.

19. The vehicle of claim 16, wherein the one or more first capacitors are ceramic capacitors, the one or more second capacitors are electrolytic capacitors, and the one or more third capacitors are film capacitors.

20. The vehicle of claim 19, wherein the one or more first capacitors form a first row adjacent to the first end and that extends between the first side and the second side, the one or more second capacitors form a second row adjacent to the first row and that extend between the first side and the second side, and the one or more third capacitors form a third row that is adjacent to the second row and the second end and extends between the first side and the second side.
